(19) United States
(12) Patent Application Publication
(10) Pub. No.: US 2020/0151015 A1
(43) Pub. Date: May 14, 2020

(54) DIGITAL CURRENCY MINING DEVICE AND DIGITAL CURRENCY MINING MANAGEMENT METHOD

(71) Applicant: ASUSTEK COMPUTER INC., TAIPEI (TW)

(72) Inventors: Quan ZHAO, TAIPEI (TW); Chien-Lung CHANG, TAIPEI (TW); Kuo-Chung KAO, TAIPEI (TW); Jie WU, TAIPEI (TW); JanLong CHEN, TAIPEI (TW); Lei JIANG, TAIPEI (TW); Yuan YANG, TAIPEI (TW)

(21) Appl. No.: 16/680,931

(22) Filed: Nov. 12, 2019

(30) Foreign Application Priority Data
Nov. 13, 2018 (CN) 201811346127.3

(51) Int. Cl. G06F 9/50; G06F 9/48; A63F 13/30; G06Q 20/06

(52) U.S. Cl. CPC G06F 9/5011; G06F 9/5027; G06Q 20/065; G06F 9/5072; A63F 13/30; G06F 9/4881

(57) ABSTRACT

A digital currency mining device and a digital currency mining management method are provided. The digital currency mining device includes a processing module and a resource allocation module. The processing module provides a resource to execute at least one mining task and at least one display task. The resource allocation module is electrically connected with the processing module, confirms whether the processing module includes one display task in execution or not, and adjusts the resource provided for the mining task by the processing module according to the display task in execution.

### CROSS-REFERENCE TO RELATED APPLICATION

This application claims the priority benefit of Chinese Application Serial No. 201811346127.3, filed on Nov. 13, 2018. The entirety of the above-mentioned patent application is hereby incorporated by reference herein and made a part of specification.

### BACKGROUND OF THE INVENTION

### Field of the Invention

The disclosure relates to a digital currency.

### Description of the Related Art

A lot of professional technologies and knowledge are needed for mining task. A mining program is executed by joining or allocating varies mining pools according to different currencies, and registering to corresponding digital currency wallet services, which are complicated processes.

Besides, lots of computer resources are consumed while mining, and a computer commonly cannot execute other tasks when mining work is performed simultaneously.

### BRIEF SUMMARY OF THE INVENTION

The disclosure provides a digital currency mining device, including a processing module and a resource allocation module. The processing module provides a resource to execute at least one mining task and at least one display task. The resource allocation module is electrically connected with the processing module, confirms whether the processing module includes one display task in execution or not, and adjusts the resource provided by the processing module for the mining task according to the display task in execution.

The disclosure also provides a digital currency mining management method adapted to manage a processing module. The processing module provides a resource to execute at least one mining task and at least one display task. The digital currency mining management method includes following steps: confirming whether the processing module includes one display task in execution or not; and when the processing module includes the display task in execution, adjusting the resource provided by the processing module for the mining task according to the display task in execution.

The digital currency mining device and the digital currency mining management method disclosed by the disclosure adjust a mining hash rate provided by the processing module, which ensures a normal operating of the display task. The disclosure provides here also simplifying a registration program when a user performs mining, thus lowers the threshold for users to participate in mining.

Specific embodiments of the disclosure will be further described by using the following examples and drawings.

### BRIEF DESCRIPTION OF THE DRAWINGS

FIG. 1 is a box schematic view of an embodiment of a digital currency mining device of the disclosure.

FIG. 2 is a schematic view of an embodiment of a login interface displayed by a display module of the digital currency mining device of the disclosure.

FIG. 3 and FIG. 4 are schematic views of an embodiment of an integrated viewing interface displayed by the display module of the digital currency mining device of the disclosure.

FIG. 5 is a flow chart of an embodiment of a digital currency mining management method of the disclosure.

### DETAILED DESCRIPTION OF THE EMBODIMENTS

Specific embodiments of the disclosure will be described in further detail below with reference to schematic drawings. The advantages and features of the disclosure will become more apparent from the following description and claims. It should be noted that the drawings are all in a very simplified form and are not drawn to accurate scale, but are merely used for convenience and clarity of description of the embodiments of the disclosure.

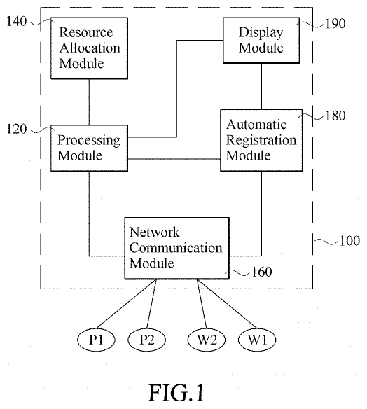

FIG. 1 is a box schematic view of an embodiment of a digital currency mining device of the disclosure. The digital currency mining device 100 includes a processing module 120, a resource allocation module 140, a network communication module 160, an automatic registration module 180 and a display module 190. In one embodiment, the digital currency mining device 100 is a computer host. The resource allocation module 140 and the automatic registration module 180 are installed on the computer host in a software manner, and are executed by a processor of the computer host. However, the disclosure is not limited herein. In another embodiment, the resource allocation module 140 also includes a firmware.

The processing module 120 provides a resource to execute at least one mining task and at least one display task. The display tasks include image display of 3D games, playing of audio and video files, and the like. In one embodiment, the processing module 120 is a processor, such as a central processing unit (CPU), a graphic processing unit (GPU), and an application specific integrated circuit (ASIC) processor. In some other embodiments, the processing module 120 is a display card.

The resource allocation module 140 is used for confirming whether the processing module 120 includes one display task in execution or not, and adjusting the resource provided by the processing module 120 for the mining task according to the display task in execution.

In one embodiment, when the display task in execution is a 3D game, the resource allocation module 140 immediately requests the processing module 120 to stop providing the resource for the mining task. In one embodiment, when the resource allocation module 140 confirms that the processing module 120 includes the display task in execution, the resource allocation module 140 preferentially provides the resource of the processing module 120 for the display task in execution.

Besides, in one embodiment, when the resource allocation module 140 detects environmental factors, such as network off line and network instability, affecting mining efficiency through the network communication module 160, the resource allocation module 140 immediately requests the processing module to decrease or stop the resource provided for the mining task.

The network communication module 160 connects with at least one mining pool (two mining pools P1 and P2 are showed in the figure as an example). The automatic registration module 180 is automatically connected to the mining pools P1 and P2 to perform registration through the network communication module 160 according to registration data, such as an account number, a telephone number and a miner name, of a user. When the registration is completed, the automatic registration module 160 automatically executes the corresponding mining task in the mining pool which successfully registrated.

A mining task commonly needs to allocate excavated digital currency to a compatible wallet. In one embodiment, the automatic registration module 180 is automatically connected to at least one wallet service (there are two wallet services W1 and W2 showed in the figure as an example) to register according to the registration data of the user so as to obtain a wallet address.

In one embodiment, the automatic registration module 180 dynamically updates wallet information, and automatically registers all wallets relevant to the digital currency after the user registers the mining pool. After obtaining the wallet address, the automatic registration module 180 is connected to the mining pool to register in cooperation with the above-mentioned registration data of the user by utilizing data of the wallet address.

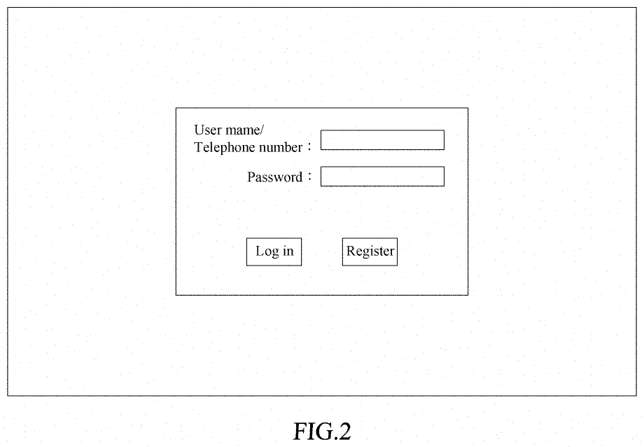

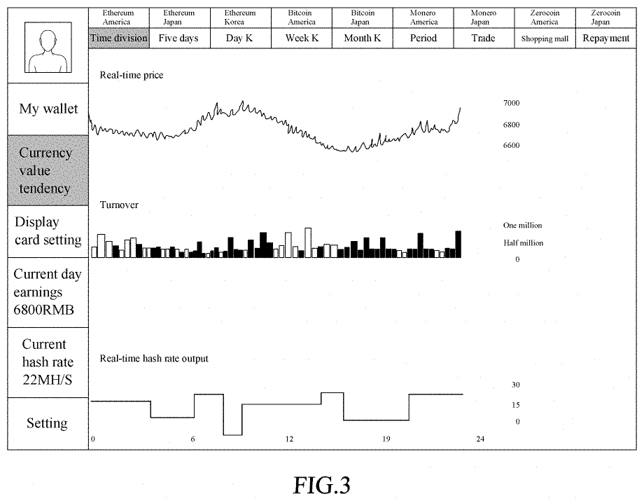

The display module 190 provides a login interface and an integrated viewing interface for the user to log in and view the mining progress. FIG. 2 is a schematic view of an embodiment of the login interface displayed by the display module of the digital currency mining device of the disclosure. FIG. 2 and FIG. 3 are schematic views of an embodiment of the integrated viewing interface displayed by the display module of the digital currency mining device of the disclosure.

As shown in FIG. 2, the login interface is used for the user to input the registration data of the user, so as to facilitate the automatic registration module 180 to register. After the user completes registration, the user logs in to the digital currency mining device 100 of the disclosure just by inputting simple identity recognizing data (such as a telephone number, a user name and an E-mail box) and passwords, connection to each of the registered mining pools is achieved through the digital currency mining device 100 of the disclosure, using of each of the registered wallets is achieved, and the corresponding mining task is automatically executed.

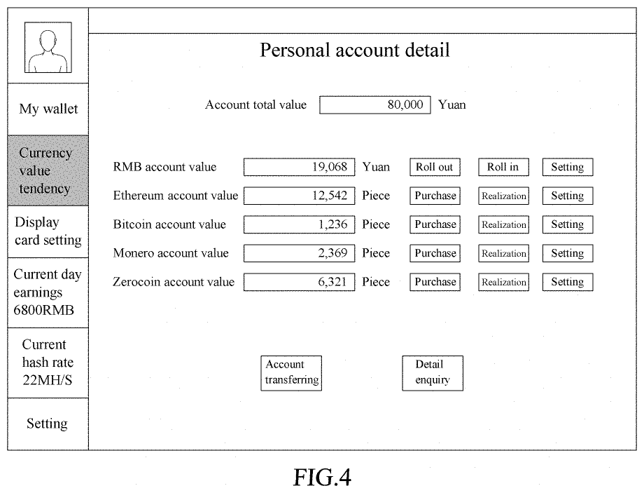

As shown in FIG. 3 and FIG. 4, the integrated viewing interface integrates information such as the mining pool, the wallet, earnings and the mining hash rate of the processing module, so that the user views the mining progress and a current circumstance of an account in real time. As shown in FIG. 3, in one embodiment, the display module 190 further acquires market information, such as turnover and price, of various digital currencies through the network communication module 160 to be shown on the integrated viewing interface. As shown in the figure, the integrated viewing interface immediately displays the tendency of Ethereum, Bitcoin, Monero and Zerocoin. As shown in FIG. 4, in one embodiment, the integrated viewing interface also integrates account details of each wallet, so that the user performs trading and querying immediately.

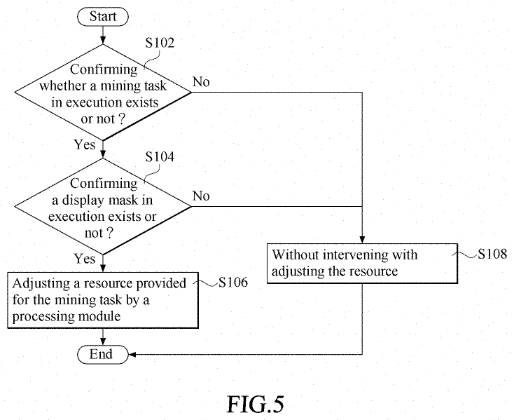

FIG. 5 is a flow chart of an embodiment of a digital currency mining management method of the disclosure. The digital currency mining management method is adapted to manage a processing module 120. The processing module 120 provides a resource to execute at least one mining task and at least one display task. The digital currency mining management method includes the following steps:

Firstly, as said in step S102, a resource allocation module 140 is used for confirming whether one mining task in execution exists or not.

When a judgment result of step S102 is yes, the process goes forwards to step S104. In step S104, the resource allocation module 140 is used for confirming whether one display task in execution exists or not. When the judgment result of step S102 is not, the process goes forwards to step S108, and the resource allocation module 140 does not intervene with adjusting resource allocation of the processing module 120.

When a judgment result of step S104 is yes, the process goes forwards to step S106. In step S106, the resource allocation module 140 is used for adjusting the resource provided by the processing module 120 for the mining task according to the display task in execution. When the judgment result of step S104 is not, the process goes forwards to step S108, and the resource allocation module 140 does not intervene with adjusting resource allocation of the processing module 120.

In an embodiment of step S106, when it is confirmed that the processing module 120 includes the display task in execution, the resource of the processing module 120 is preferentially provided for the display task. In one embodiment of step S106, when the display task in execution of the processing module 120 is a 3D game, it immediately stops providing the resource of the processing module 120 for the mining task.

Compared with a traditional complex mining registration program, the digital currency mining device and the digital currency mining management method provided by the disclosure adjust a mining hash rate provided by the processing module, guarantee normal operating of the display task, and simplify a registration program when the user performs mining, so that a threshold for the user to participate in mining is lowered.

Although the disclosure has been described with reference to the above embodiments, the embodiments are not intended to limit the disclosure. A person of ordinary skill in the art may make variations and improvements without departing from the spirit and scope of the disclosure. Therefore, the protection scope of the disclosure should be subject to the appended claims.

What is claimed is:

1. A digital currency mining device, comprising:
a processing module, providing a resource to execute a mining task and a display task; and
a resource allocation module, electrically connected with the processing module, confirming whether the processing module has the display task in execution or not, and adjusting the resource provided by the processing module for the mining task according to the display task in execution.

2. The digital currency mining device according to claim 1, further comprising:
a network communication module, connecting with a mining pool; and
an automatic registration module, electrically connecting with the network communication module and automatically connecting to the mining pool to register according to registration data of a user, wherein the mining task corresponds to the mining pool registered and the registration data of the user.

3. The digital currency mining device according to claim 2, wherein after the automatic registration module completes registration, the processing module automatically executes the corresponding mining task.

4. The digital currency mining device according to claim 2, wherein the automatic registration module automatically connects to a wallet service to register according to the registration data of the user.

5. The digital currency mining device according to claim 1, wherein when the display task in execution is a 3D game, the resource allocation module stops providing the resource for the mining task.

6. The digital currency mining device according to claim 1, wherein when the resource allocation module confirms that the processing module has the display task in execution, the resource allocation module preferentially provides the resource of the processing module for the display task in execution.

7. A digital currency mining management method, adapted to manage a processing module, the processing module providing a resource to execute a mining task and a display task, wherein the digital currency mining management method comprises following steps:
confirming whether the processing module has the display task in execution or not; and
when the processing module has the display task in execution, adjusting the resource provided for the mining task by the processing module according to the display task in execution.

8. The digital currency mining management method according to claim 7, wherein when the display task in execution is a 3D game, the step of providing the resource of the processing module for the mining task is stopped.

9. The digital currency mining management method according to claim 7, wherein when it is confirmed that the processing module has the display task in execution, the resource of the processing module is preferentially provided for the display task.
